(19) United States
(12) Patent Application Publication
(10) Pub. No.: US 2026/0087218 A1
(43) Pub. Date: Mar. 26, 2026

(54) SYSTEMS AND METHODS FOR IDENTIFYING AND MODIFYING UNUSED LOGIC IN CIRCUIT DESIGNS

(71) Applicant: QUALCOMM Incorporated, San Diego, CA (US)

(72) Inventors: Saravanan Manickam, San Diego, CA (US); Madan Krishnappa, San Diego, CA (US); Pavan Kumar Patibanda, San Diego, CA (US); Noman Ahmed, San Diego, CA (US); Pavithra Bangalore Narayana, San Diego, CA (US)

(21) Appl. No.: 18/895,002

(22) Filed: Sep. 24, 2024

(51) Int. Cl. G06F 30/3312; G06F 30/323; G06F 119/12

(52) U.S. Cl. CPC G06F 30/3312; G06F 30/323; G06F 2119/12

(57) ABSTRACT

This disclosure provides systems, methods, and devices that support enhanced circuit design operations, including floating port identification and floating port-based modifications, and enhanced circuits with floating port-based modifications. In a first aspect, a method for circuit design includes: analyzing library file information for a design block of a plurality of design blocks for a circuit plan to identify floating port information for the library file information. The method also include identifying unused logic of the design block for the circuit plan based on the floating port information, and adjusting the design block for the circuit plan based on the identified unused logic of the design block for the circuit plan. The method further includes outputting a netlist file for the circuit plan based on the adjusted design block. Other aspects and features are also claimed and described.

### TECHNICAL FIELD

Aspects of the present disclosure relate generally to apparatuses and methods for Very-large-scale integration (VLSI) techniques for circuit designs. Some aspects may, more particularly, relate to enhanced VLSI operations for identifying unused ports and logic and modifying or optimizing circuit designs.

### INTRODUCTION

System-on-a-chip (SoC) designs and mobile devices are becoming more complex, implementing smaller physical profiles with ever-decreasing conductor path dimensions for transferring data at higher rates than predecessor SoCs. Operating at higher speeds with greater physical design constraints may increase power demands.

Semiconductor devices such as Integrated Circuits (ICs), System-On-a-Chip (SOC), or other chips often have millions or even billions of transistors. These devices are often designed at a higher level using Register-Transfer-Level (RTL) descriptions that specify logical operation of the chip but do not specify the specific gate level components such as transistors or logic gates. Computer-Aided-Design (CAD) software and tools allow designers to specify chip operation at a higher level, increasing efficiency and time to-market. CAD software later creates the gates, transistors, and wiring needed to implement the logical behavior specified in the RTL.

Semiconductor devices are often designed using a Very-large-scale integration (VLSI) process. VLSI design or Structured VLSI design is a modular methodology for reducing microchip area. One principle of this design technique is to design the circuit or portions thereof with a repetitive arrangement of rectangular macro blocks (e.g., referred to as hard macros) which can be interconnected using wiring by abutment. An example is partitioning the layout of an adder into a row of equal bit slice cells. In complex designs, this structuring may be achieved by hierarchical nesting of a larger macro block being constructed of multiple sub-macro blocks. However, this patterning technique, while saving time and reducing area, can also impart waste, in terms of unused logic and/or space. For example, a particular macro block that is incorporated into the design, or into a larger macro block thereof, may be repeated thousands or millions of times. A particular unused port, or logic connected thereto, may be repeated thousands or millions of times leading to repeating this inefficiency, which leads to larger chips with higher power consumption.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects disclosed herein describe enhanced semiconductor design apparatuses and methods for identifying unused logic, such as unused logic in macro block of VLSI designs. The semiconductor design architectures and designs enable identification of unused logic by identifying unused or unconnected ports or pins of macro blocks, referred to as floating ports or pins. By identifying the floating ports of the design blocks and incorporating this information into the VLSI design process, a semiconductor chip may be optimized by identifying unused logic of the design and modifying the design based on the unused logic.

In one aspect of the disclosure, a method for circuit design includes: analyzing library file information for a design block of a plurality of design blocks for a circuit plan to identify floating port information for the library file information; identifying unused logic of the design block for the circuit plan based on the floating port information; adjusting the design block for the circuit plan based on the identified unused logic of the design block for the circuit plan; and outputting a netlist file for the circuit plan based on the adjusted design block.

In another aspect, a method for circuit design includes: obtaining Extracted Timing Model (ETM) information for a plurality of design blocks of a circuit design, the ETM information indicating hierarchical timing information for the plurality of design blocks; identifying floating port information for at least one design block of the plurality of design block; modifying the ETM information based on the identified floating port information; obtaining top level register transfer level (RTL) information for the plurality of design blocks, the RTL information indicating top level RTL designs for the plurality of design blocks; determining an engineering change order (ECO) for the at least one design block based on the identified floating port information for the at least one design block; updating netlist information for the at least one design block based on the ECO; performing top level synthesis for the circuit design based on the top level RTL information and the modified ETM information to generate top level synthesis information; performing a logical equivalence check (LEC) between the top level RTL information and the updated netlist information to determine LEC update data; performing a LEC on the top level synthesis information based on the LEC update data; validating the updated netlist information based on performance of the LEC on the top level synthesis information; and outputting a validated netlist file based on validation of the updated netlist information, the validated netlist file generated based on the identified floating port information and including modified logic associated with the ECO.

In yet another aspect, a hard macro of an integrated circuit comprises: a first plurality of input ports coupled to one or more neighboring hard macros of the integrated circuit; a first plurality of output ports coupled to the one or more neighboring hard macros, the first plurality of input port and the first plurality of output ports coupled to a supply voltage of the integrated circuit; and one or more floating input ports or floating output ports that are not connected to any other hard macros of the integrated circuit, the one or more floating input ports or floating output ports are not coupled to any supply voltage of the integrated circuit.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a system including a computing device according to some aspects of the disclosure.

FIG. 2 is a flow diagram illustrating an example of VLSI operations according to some aspects of the disclosure.

FIG. 3 is a block diagram illustrating an example of an apparatus configured for enhanced circuit design operations and identifying floating ports and unused logic according to one or more aspects of the disclosure.

FIG. 4 is a flow diagram illustrating an example of enhanced VLSI operations according to some aspects of the disclosure.

FIG. 5 is a block diagram illustrating an example of a design of an SoC with multiple design levels according to some aspects of the disclosure.

FIG. 6 is a block diagram illustrating an example of a design of top level operations with modifications based on identified floating port information according to some aspects of the disclosure.

FIG. 7 is a block diagram illustrating an example of a design of block level operations with modifications based on identified floating port information according to some aspects of the disclosure.

FIG. 8 is a flow chart illustrating an example of a method for enhanced circuit design operations according to some aspects of the disclosure.

FIG. 9 is a flow chart illustrating another example of a method for enhanced circuit design operations according to some aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

The term “system-on-a-chip” (SoC) is used herein to refer to a set of interconnected electronic circuits typically, but not exclusively, including a processing device, a memory, and a communication interface. A processing device may include a variety of different types of processors and processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

As used herein, the term “computing device” refers to any one or all of vehicle management systems, display sub-systems, driver assistance systems, vehicle controllers, vehicle system controllers, vehicle communication system, infotainment systems, vehicle display systems or subsystems, vehicle data controllers or routers, cellular telephones, smart phones, personal or mobile multi-media players, personal data assistants (PDAs), laptop computers, personal computers, tablet computers, smart books, palm-top computers, wireless electronic mail receivers, multimedia Internet enabled cellular telephones, vehicle controllers, and similar electronic devices which include a programmable processor and memory and circuitry configured to perform operations as described herein.

Various embodiments include methods and systems for identifying unused ports and logic and modifying or optimizing circuit designs, such as circuit designs made by Very-large-scale integration (VLSI) operations. The methods and systems described herein may produce modified and/or optimized designs for circuit components, including SoCs and components thereof, with reduce unused logic. Various embodiments may be configured to identify unused ports and logic automatically in large complex circuit plans, such as at a block or component level, and may be able to automatically, or semi-automatically, modify the circuit designs to remove or reduce the impact of the unused ports and logic based on the identified or unused ports.

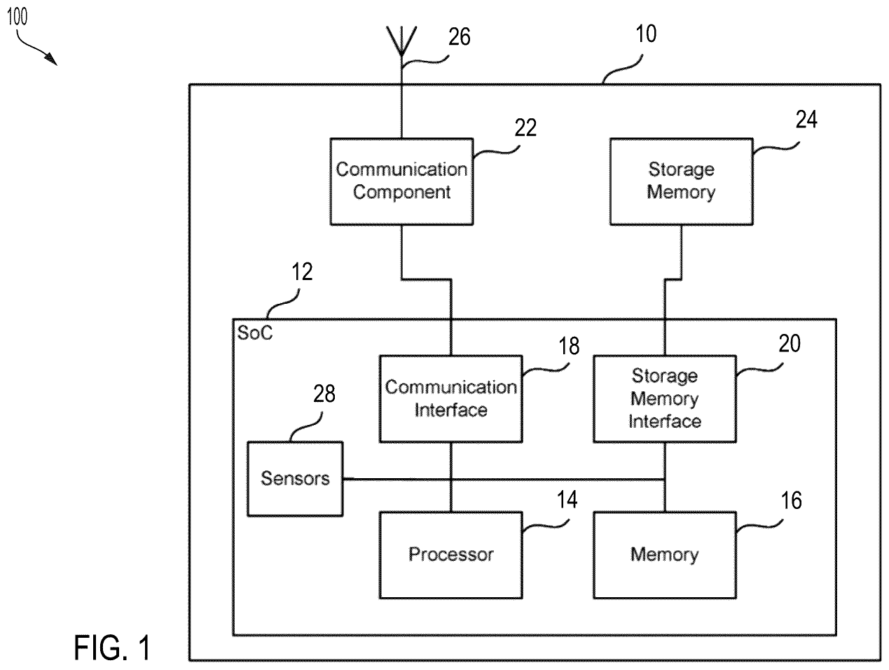

FIG. 1 illustrates a system including a computing device 10 suitable for use with various embodiments or including one or more components that were designed and produced by various embodiments described herein. For example, the computing device 10 may include one or more components that are designed by and/or produced by a circuit design generated by the embodiments described herein, such as a circuit design that is modified based on identified floating or unused ports and logic. The computing device 10 may be included in a mobile computing device, such as a wireless communication device, according to one or more aspects of the disclosure. As other examples, the computing device 10 may be included in an MP3 player, a laptop computer, or a non-portable electronic device such as a desktop computer, a game player, a television (TV), a media player, or an automotive computer system. The computing device 10 may include an SoC 12 with a processor 14, a memory 16, a communication interface 18, a storage memory interface 20, and sensors 28. The computing device 10 may further include a communication component 22, such as a wired or wireless modem, a storage memory 24, and an antenna 26 for establishing a wireless communication link. The processor 14 may include any of a variety of processing devices, for example a number of processor cores.

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster. The processors 14 may control the general operations of SoC 12 and optionally the specific actions of any of the components thereof. The processors 14 may be implemented, for example, with a microprocessor or a central processing unit (CPU), or an application-specific integrated circuit (ASIC).

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. As illustrative examples of volatile memories, the one or more memories 16 may include a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24. The storage memory interface 20 may include or correspond to a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The sensors 28 may be communicatively coupled to the processor 14, the memory 16, the communication interface 18, and the storage memory 20 via a bus or other communication link. The sensors 28 may include thermal sensors and/or voltage sensors physically located within the SoC 12. The sensors 28 may measure thermal and electrical characteristics (e.g., temperature and voltage values) throughout the SoC 12 during testing and normal operating procedures as described by embodiments. Temperature values and voltage values measured by the sensors 28 may be conveyed to the processor 14 for processing, stored in the memory 16, and/or conveyed from the SoC 12 through the communication interface 18 to other components in the computing device 10.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device 10. For example, the communication interface 18 may be used to convey measured in-field characteristics to the communication component 22. The communication component 22 may relay the measured in-field characteristics to external additional computing devices for purposes of diagnosing any errors based on the in-field characteristics. Similarly, the memory 16, storage memory interface 20, and storage memory 24 may store and convey the measured in-field characteristics and other associated data as according to the various embodiments.

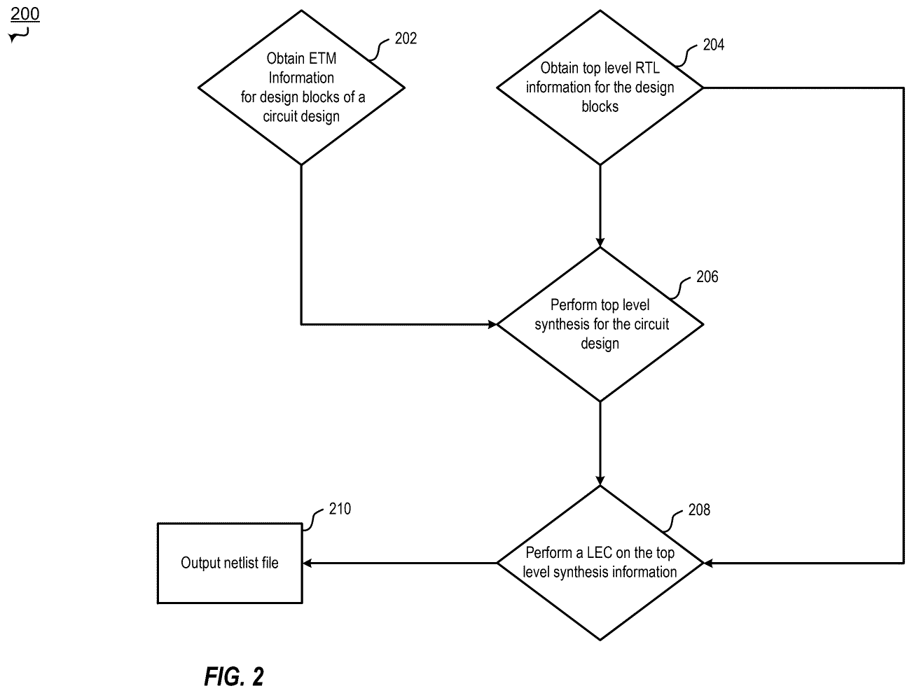

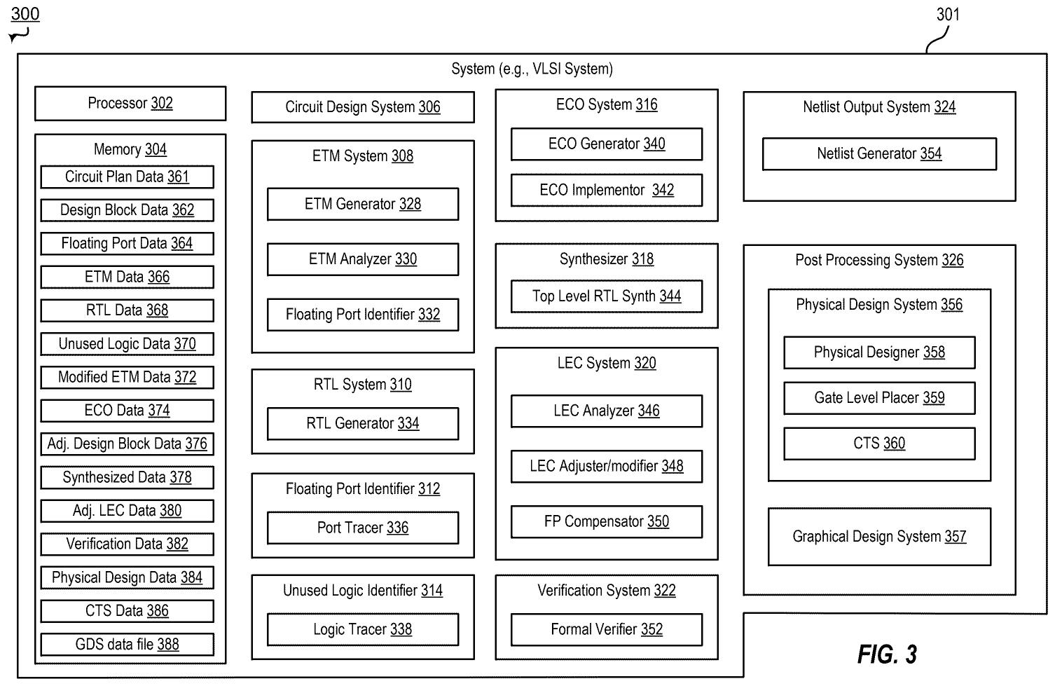

Referring to FIG. 2, FIG. 2 is a flow diagram 200 illustrating circuit design operations according to some embodiments of the disclosure. In some implementations, the blocks or operations of the flow diagram 200 may be performed by system 301 of FIG. 3, and any components thereof.

At block 202, the system obtains extracted timing model (ETM) information for design blocks of a circuit design. For example, the system receives or generates ETM information for design blocks of a particular circuit design and for a particular circuit design. To illustrate, the system may receive or generate an ETM file, such as a library file, for each design block of the circuit plan. The ETM files may correspond to blocks at different levels of the circuit design, such as DL1, DL2, DL3, etc.

In some implementations, the system may receive ETM information for one or more blocks of a particular design that was generated by another device. In other implementations, the system may generate the ETM information based on block information. To illustrate, the system may generate ETM information based on CAD design file information and/or circuit design information. The ETM information includes hierarchical timing information. In a particular implementation, the ETM information does not indicate components of the block, but rather a signal flow or routing of the block and related timing formation for the signal flow or routing.

At block 204, the system obtains top level register transfer level (RTL) information for the design blocks of the particular circuit design. For example, the system receives or generates top level RTL information for the design blocks for the particular circuit design. In some implementations, the system may receive top level RTL information for one or more blocks of the particular design that was generated by another device. In other implementations, the system may generate the top level RTL information based on block information. To illustrate, the system may generate the top level RTL information based on CAD design file information and/or circuit design information. The top level RTL information may include or correspond to information regarding a design abstraction of the block which models the block (e.g., components thereof) in terms of the flow of digital signals (data) between hardware registers, and the logical operations performed on those signals. The block may be modeled as a synchronous digital circuit of the overall circuit or design plan for the semiconductor device or SoC. The top level RTL information may be in a hardware description language (HDL), such as Verilog or VHDL. The top level RTL includes or corresponds to a high-level representation of the circuit, from which lower-level representations and ultimately actual wiring can be derived.

At block 206, the system performs top level synthesis for the circuit design. For example, the system performs top level synthesis for the circuit design based on the ETM information and the top level RTL information to generate top level synthesis information. To illustrate, the system may combine or synthesize the information from the ETM files and the top level RTL files to generate netlist information, such as a netlist file. The generated netlist information, such as netlist file(s), may be for the circuit design as a whole and/or for the individual blocks.

In some implementations, an RTL description of the block is converted to a gate-level description of the block by a logic synthesis tool, such as Synopsis. The synthesis results may be used for placement and routing tools to create a physical layout of the block and circuit.

At block 208, the system performs a logic equivalence check (LEC) on the top level synthesis information. For example, the system performs an LEC on the top level synthesis information to verify the gate level placement from the timing information and/or RTL information. To illustrate, the system uses a logic simulation tool to verify the correctness of the top level synthesis information (e.g., netlist file(s)) based on the RTL description of the top level RTL information, and optionally the timing information of the ETM information. This may be done at the block level or circuit level. Logic simulation tools may use a design's RTL description to verify its correctness after synthesis.

At block 210, the system outputs a netlist file based on the performance of the LEC. For example, the system outputs a netlist file or files based on the performance of the LEC. To illustrate, the system generates a verified or final netlist file for the circuit and/or verified or final netlist files for the blocks thereof.

The netlist file or files may be provided to a physical design team and/or physical design software/tool for a physical design stage of the circuit plan. The physical design stage may include gate level or component (e.g., transistor) level placement and routing based on the gate level information in the netlist, that was generated based on ETM information and RTL information. The physical design stage may include clock signal tracing and connecting, such as clock tree synthesis (CTS) for the gates/components after placement. After the physical design stage is complete, the circuit may proceed to graphic design system (GDS) for creation of GDS file for use in fabrication. The GDS file may include all of the physical information of the circuit design.

In the above process of FIG. 2, the designs of the individual blocks that make up the circuit are fixed or set when designing the circuit. That is the blocks (cells or hard macros) which are repeated to form the larger circuit that have fixed components, such as fixed ports, pins and logic. In designing a circuit, such as with a VLSI process, the circuit may be built using multiple layers of blocks, each layer referred to as a design level. A particular design level may have one or more types of blocks (cells or hard macros), which each may include or be comprised of one or more types of blocks of a lower design level. As an illustrative example, a top level component may be a modem, and the modem includes multiple different components of a lower level, one of those being a memory register. The modem may be designed using the blocks of a lower level. Additionally, the memory register may itself include different components from a lower level, and one example of those may be a memory cell or latch.

Some of these fixed components of a block (or blocks) may be unused in a given design. For example, a particular design block (B1) at design level 3 (D3) when incorporated into a second particular design block (B2) at design level 2 (D2) may not use certain pins or logic that are included in the design. In the above process, these unused components are incorporated into the design. These unused components lead to reduced efficiency in the design in that a particular unused port/pin and accompanying logic may occur thousands or millions of times in the overall circuit design. The unused components take up additional circuit area, create power leakage, and create manufacturing costs. In the current semiconductor design process and tools, the semiconductor design process is so complex, including billions of components, that even optimizing blocks of components for the particular design is not possible.

In the aspects described herein, apparatuses and methods are described to enhance semiconductor design and VLSI generally by enabling modification or adjustments of blocks or cells that make up a larger design to improve efficiency. In some aspects, apparatuses and methods are described, to identify unused logic in blocks of a larger design and to modify the design to reduce the impact from the identified unused logic. For example, floating ports (e.g., unused or not connected ports/pins) may be identified in blocks used in a particular circuit design by using ETM and/or RTL information early in the design process. The floating port information may be leveraged to identify unused logic prior to physical design and gate level placement, so that the effects of the unused logic may be mitigated. The unused logic may be removed, disconnected, repurposed, etc. to enhance or otherwise optimize the design.

In a particular aspect, the floating port information may be identified based on ETM and/or RTL information associated with a circuit design, and the ETM information may be modified to identify the floating ports. For example, the ETM information may include indications of floating ports (qflot) or a separate list of all the floating ports. This floating port information may then be used during top level synthesis and conversion from ETM and RTL designs to gate level equivalencies (e.g., synthesis or netlist information) to remove or compensate for the unused logic. The synthesis or netlist information may then also be verified based on the floating port information to ensure the verification process also accounts for the floating port and/or unused logic. Thus, when the verified gate level equivalence design (synthesis or netlist information) is provided to the physical design stage its design has been modified based on the identified floating ports. For example, all of the unused logic associated with the floating ports may be disconnected (e.g., gap in trace or switch placed) to reduce power leakage. As another example, the unused logic associated with the floating ports are not included in the design and such logic (e.g., gated and transistors thereof) will not be incorporated into the design.

FIG. 3 illustrates an example 300 of a system 301 that supports enhanced circuit design operations in accordance with aspects of the present disclosure. In some examples, the system 301 may produce a circuit design for the SoC 100 of FIG. 1. For example, the system 301 may perform one or more operations of the methods or flows described herein to identify floating port information and modify a circuit design based on the floating port information. This process may include identifying unused logic associated with (e.g., connected or coupled to) the floating port and modifying the port and/or unused logic to improve the operation or design of the circuit, such as to reduce area, power consumption or leakage, etc. The system may include a processing system with one or more devices or components that perform the enhanced circuit design operations.

System 301 may be configured to communicate with one or more sub-systems or devices thereof and/or with one or more external systems or devices. For example, the system 301 may be configured to communicate via one or more wired or wireless interfaces. When communicating via a wireless interface, the system 301, including one or more sub-systems or devices thereof, may communicate with one or more portions of the electromagnetic spectrum associated with Bluetooth transmissions, Wi-Fi transmissions, or cellular transmissions (including sub-6 GHz and 6 GHz).

System 301 can include a variety of components (e.g., structural, hardware components) used for carrying out one or more functions described herein. For example, these components can include a processing system and memory configured to perform enhanced circuit design and optimization, along with wired and/or wireless communication components, such as a transceiver, an encoder, a decoder, and one or more antennas (not shown in FIG. 3 for simplicity).

The system 301 (e.g., a device or devices thereof) includes one or more processors and one or more corresponding memories. As illustrated in the example of FIG. 3, the system 301 includes a representative processor 302 and a representative memory 304. Processor 302 may be configured to execute instructions stored at memory 304 to perform the operations described herein. In some implementations, processor 302 includes or corresponds to the processing system and/or the processor 14 of FIG. 1, and memory 304 includes or corresponds to the memory 16 of FIG. 1. Memory 304 may also be configured to store information and data for enhanced circuit design operations, floating port identification operations, unused logic identification operations, floating port and unused logic change operations, or a combination thereof, as further described herein.

For example, the memory 304 may be configured to store one or more of circuit plan data 361, design block data 362, floating port data 364, ETM data 366, RTL data 368, unused logic data 370, modified ETM data 372, ECO data 374, adjusted design block data 376, synthesized data 378, adjusted LEC data 380, verification data 382, physical design data 384, CTS data 386, or a GDS data file 388.

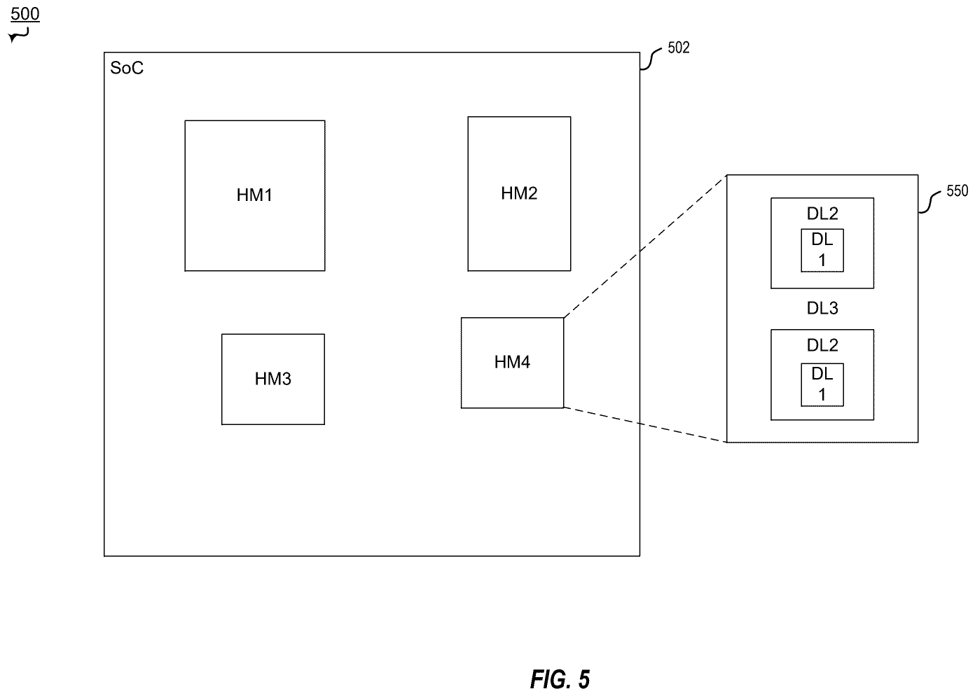

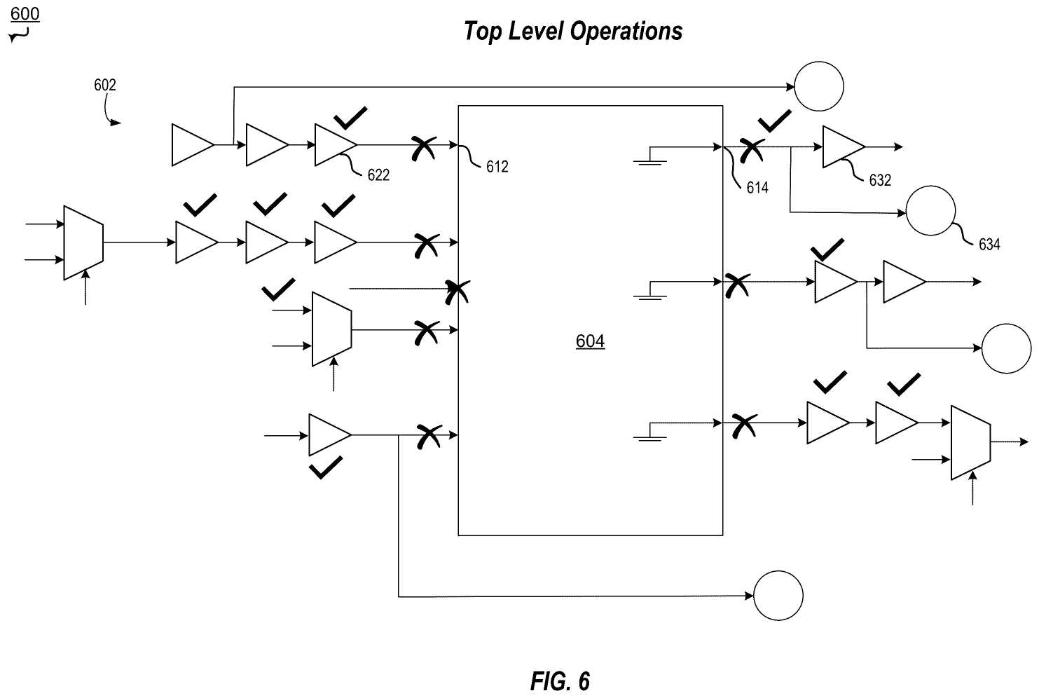

The circuit plan data 361 may include or correspond to circuit plan design data for a particular circuit. The circuit plan data 361 may include a list of hard macros or blocks and for multiple levels or layers of the circuit design. The circuit plan data 361 may include an arrangement of the blocks for multiple levels or layers of the circuit design. For example, the circuit plan data 361 may include a list and an amount of types of blocks for each layer, and a list and an amount of subblocks of the block or layer. As an example, the circuit plan data 361 may include the information of FIGS. 5-6.

The design block data 362 may include or correspond to block level design data for one or more blocks. The design block data 362 may include or correspond to block level detail for each block in a block database or for a particular circuit plan or design. The design block data 362 may include component lists or level details for the blocks, port and pin information for the blocks, timing data for the blocks, etc. The design block data 362 may correspond to a hard macro or cell database and include designs for multiple components of the circuit.

The design block data 362 may include or correspond to block level design data for hard macros of a database of blocks or a database of blocks for a particular circuit or area. The design block data 362 may include block level detail for hard macros. The pin information for the blocks may be fixed or static. Thus, when the block or lower level blocks are inserted to higher level blocks or a top level design, the upper layer and/or the lower layer may not have any knowledge of which ports, pins, and/or logic is not being used for a given design or for a particular block or macro.

The floating port data 364 (floating port information) may include or correspond to unconnected or disconnected port or pin data for one or more blocks of the blocks of the circuit design. The floating port data 364 may indicate or identify ports or pins which are not used for a particular block in a particular upper layer or level block or design. The floating ports may correspond to ports between blocks of different design levels or layers of the circuit or between two blocks of a same level that are not used or coupled to active/used logic.

The ETM data 366 may include or correspond to an ETM file, such as an ETM library file. The ETM data 366 include or indicate timing information, such as hierarchical timing information. The ETM file and/or timing information thereof for a particular block may be generated based on a hierarchical timing analysis of the design block, the circuit, or both. The hierarchical timing analysis may be performed on a netlist corresponding to the block (e.g., gate level information for the block), RTL information corresponding to the block (register information), or both.

The RTL data 368 may include or correspond to RTL data for one or more blocks of the blocks of the circuit design. The RTL data 368 may indicate or identify, or otherwise correspond to, information regarding a design abstraction of the components which model the blocks (e.g., components thereof) in terms of the flow of digital signals (data) between hardware registers, and the logical operations performed on those signals. The RTL data may model the block as a synchronous digital circuit of the overall circuit or design plan for the semiconductor device or SoC. The top level RTL information may be in a hardware description language (HDL), such as Verilog or VHDL.

The unused logic data 370 may include or correspond to logic that is associated with unconnected or disconnected port or pin data for one or more blocks. The unused logic data 370 may indicate logic associated with, such as coupled to, connected to, driven by, etc., the identified floating ports or pins which are not used for the block in the particular circuit design. The unused logic data 370 may be used to modify the circuit design to optimize or enhance the circuit design by modifying the individual blocks thereof to reduce or remove the negative impact(s) of the unused logic.

The modified ETM data 372 may include or correspond to a modified ETM file or modified ETM information that is modified based on the floating port data 364. The modified ETM data 372 may include indications for floating ports, a list of floating ports, floating port association data, unused logic indication data, or a combination thereof.

The ECO data 374 may include or correspond to data for a particular block level design change. The ECO may be generated based on the floating port data 364 directly or indirectly. For example, the ECO data 374 may be generated based on the modified ETM file or modified ETM information that is modified based on the floating port data 364. As another example, the ECO data 374 may be generated based on identified unused logic of the unused logic data 370 which was determined based on the floating port data 364 or based on the modified ETM file or modified ETM information. As yet another example, the ECO may be generated based on synthesis of ETM information and RTL information and the floating port data 364. In such examples, the floating port data 364 may be used directly during synthesis or as part of modified ETM and/or modified RTL information.

The adjusted design block data 376 may include or correspond to modified block level design data (e.g., design block data 362) for hard macros/cells of the database, the particular circuit which are modified based on the floating port data 364, and/or the unused logic data 370. The adjusted design block data 376 may include one or more modifications from the design block data 362 to account for or otherwise optimize the block for the floating port data 364 and/or the unused logic data 370.

The synthesized data 378 may include or correspond to netlist or synthesis information generated by a top level synthesis of ETM and RTL information. For example, the synthesized data 378 may include top level synthesis information in the form of a netlist that include gate level information and is synthesized or generated based on register information from an RTL file and timing information from an ETM file. The RTL and/or ETM files may be modified based on the identified floating port information, such that synthesized data 378 is also modified, generated, or otherwise based on the identified floating port information. For example, ECOs may be implemented in the ETM and/or RTL files prior to synthesis, or the ECOs may be generated and/or accounted for at the synthesis stage and during creation of the synthesized data 378.

The adjusted/modified LEC data 380 may include or correspond to data used for performing an LEC on the netlist or synthesis information by a top level synthesis of ETM and RTL information. The adjusted/modified LEC data 380 may include data corresponding to logical equivalence adjustments.

The verification data 382 may include or correspond to data for verifying the netlist or synthesis information generated by a top level synthesis of ETM and RTL information and/or the verified netlist or synthesis information after verification or LEC. The verification data 382 may include data used during an LEC of the netlist or synthesis information. The verification data 382 may include data that is received or generated based on the identified floating port information. For example, the verification data 382 may include logical equivalence adjustments for the logical equivalence of the ETM and RTL files to account for the ECOs made before or during top level synthesis based on the floating port information and/or unused logic associated therewith.

The physical design data 384 may include or correspond to the gate level placement information for the gate level components in the netlist or synthesis information for the circuit design. The physical design data 384 may include or correspond to a physical design file that includes dimensions and locations for gate level components.

The CTS data 386 may include or correspond to clock tracing synthesis information for the circuit. The CTS data 386 may be generated by a clock tracing process of the placed gate level components from the physical design stage.

The GDS data file data 388 may include or correspond to a graphics design system file that is provided to a circuit manufacturing provider or system, such as a semiconductor fabrication system. The graphics design system file includes information for building the circuit.

The system 301 further includes a circuit design system 306, an ETM system 308, and an RTL system 310. The circuit design system 306 is configured to generate a circuit design or circuit plan and data for or indicating the circuit design or plan, such as circuit plan data 361. The circuit design system 306 may generate the circuit design or plan, circuit plan data 361, by building the circuit from blocks, cells or hard macros of a circuit or block database, such as from design block data 362.

The ETM system 308 is configured to generate ETM data for the circuit design or plan, circuit plan data 361, and/or for the individual blocks, cells or hard macros of the circuit plan, for the design blocks of the design block data 362. The ETM system 308 may be configured to perform ETM analysis, such as timing or hierarchical timing analysis on the design blocks and/or circuit (on the respective data files or libraries) to generate the ETM data or ETM library file. The ETM system 308 may also be configured to identify the floating port information, generate the floating port information, or both, such as to generate the floating port data 364.

The ETM system 308 may include one or more sub-components to perform the functions or operations above. As illustrated in the example of FIG. 3, the ETM system 308 includes an ETM generator 328, an ETM analyzer 330, and a floating port identifier 332. The ETM generator 328 may be configured to generate ETM file data and/or modified ETM data based on the floating port information (floating port data 364). The ETM analyzer 330 may be configured to analyze the block and circuit data to generate ETM data, port connection data, or both. The floating port identifier 332 may be configured to identify ports, which are not connected between blocks or design layers of the circuit plan based on the ETM data, the port connection data or both. The floating port identifier 332 may trace port connections throughout the blocks and layers of the circuit plan to identify unconnected ports and generate the floating port data 364.

The RTL system 310 is configured to generate RTL data for the circuit design or plan, circuit plan data 361, and/or for the individual blocks, cells or hard macros of the circuit plan, for the design blocks of the design block data 362. The RTL system 310 may be configured to perform RTL analysis, such as register transfer level analysis on the design blocks and/or circuit (on the respective data files or libraries) to generate the RTL data or RTL library file. The RTL system 310 may also be configured to identify the floating port information, generate the floating port information, or both, such as to generate the floating port data 364.

The RTL system 310 may include one or more sub-components to perform the functions or operations above. As illustrated in the example of FIG. 3, the RTL system 310 includes an RTL generator 334. The RTL generator 334 may be configured to generate RTL file data and/or modified RTL data based on the floating port information (floating port data 364) and/or modified ETM data. The RTL system may optionally include an RTL analyzer and/or floating port identifier, similar to the ETM analyzer 330, and the floating port identifier 332. The RTL system may be configured to generate the floating port information in addition to, or in the alternative of, the ETM system 308 in other implementations.

The system 301 optionally includes a separate or discrete floating port identifier 312. The floating port identifier 312 may include a port tracer configured to trace ports of the blocks of the circuit plan to identify the unconnected floating ports, as described with reference to the floating port identifier 332. In such implementations, the floating port identifier 312 generates the floating port information based on tracing ETM, RTL, and/or netlist information and is separate from the ETM and/or RTM systems. In such aspects, the floating port information may be sent directly to an ECO system 316 and/or a synthesizer 318 for block modification and netlist generation.

The system 301 further includes an unused logic identifier 314, including a logic tracer 338. The unused logic identifier 314 may be configured to identify unused logic in a timing space, an RTL space, or a gate level design space, such as in ETM, RTL, or netlist information, based on the identified floating port information. The logic tracer 338 may be configured to trace the logic attached to identify the floating ports in the floating port data 364 or in a modified RTL or ETM file, and identify the unused logic. The unused logic identifier 314 may generate and output unused logic data. The unused logic data 370 may be output to the ETM system 308, the RTL system 310, and/or the ECO system 316.

The system 301 further includes the ECO system 316 for generating ECOs based on the identified floating port information. The ECO system 316 may include an ECO generator 340 and an ECO implementor 342. The ECO system 316 (e.g., the ECO generator 340 thereof) may be configured to generate one or more ECOs for the design blocks of the circuit design based on the floating port data 364, modified ETM and/or RTL files (including or indicating the floating ports), the unused logic data 370, or a combination thereof. The ECOs may be implemented in the ETM or RTL information prior to synthesis or may be implemented at the synthesis stage. For example, the ECO implementor 342 may modify the ETM and/or RTL files based directly or indirectly on the identified floating port information, such as based on the identified unused logic. As another example, the ECO implementor 342 may provide change commands to the synthesizer 318 to be used during synthesis (e.g., ignore point commands).

The system 301 further includes the synthesizer 318 including a top level RTL synthesizer 344. The synthesizer 318 is configured to perform top level synthesis of RTL and ETM information for the circuit design. For example, the top level RTL synthesizer 344 may perform synthesis of top level RTL information and modified ETM information.

The system 301 further includes an LEC system 320, including a logic tracer 338, an LEC adjuster 348, and an FP compensator 350. The LEC system is configured to perform an LEC on the synthesis information generated by the synthesizer 318 or the netlist information generated by a netlist output system 324. The logic tracer 338 may perform a logical equivalence analysis on the synthesis information or netlist file by analyzing the logical operations and flow and comparing that to the logic flow of the RTL information and/or the timing information of the ETM information. The LEC adjuster 348 is configured to make any changes to the synthesis information or netlist file to better match the logic of the synthesis information or netlist file to the original design logic of the ETM and/or RTL files. However, as the synthesis information or netlist file is generated based on the identified floating port information, the LEC system 320 needs to account for the ECOs implemented based on the identified floating port information. In some implementations, the LEC system includes an FP compensator 350 to adjust the logical equivalence analysis to account for the ECOs. For example, the LEC analyzer may adjust the logic flow or timing of the RTL and/or ETM files to ensure that the check is accurate.

The system 301 further includes the verification system 322, including a formal verifier 352. The verification system may be configured to assist with the LEC and/or other verification checks before submission of the circuit information, e.g., netlist file(s), for physical design. Also, as the circuit design may be an iterative process, the verification system 322 may enable updates to be made to the circuit design or blocks at various stages of the circuit design process and for the update to be verified for a current stage.

The system 301 further includes the netlist output system 324, including a netlist generator 354. The netlist output system 324 is configured to generate a netlist file based on performance of the top level synthesis by the synthesizer 318 and optionally based on performance of the LEC and/or verification by the LEC system 320, the verification system 322, or both. In some implementations, the netlist output system 324 is included as part of the synthesizer 318 or a part of a synthesis system, and a netlist file output by the netlist output system 324 corresponds to a netlist file generated based on the top level synthesis. Additionality, or alternatively, the netlist output system 324 is configured to generate a final or verified netlist file and provide the file to the post-processing system 326.

The system 301 further includes the post-processing system 326 including a physical design system 356 and a graphical design system (GDS) system 357. The physical design system 356 may include a physical designer 358, a gate level placer 359, and a clock trace synthesizer 360. The physical design system 356 may be configured to perform physical design operations for the output from the netlist output system 324, such as the final or verified netlist file. The physical designer and gate level placer 359 may physically place the gate level components specified in the final or verified netlist file in a design plan and route the traces between the place components in the design plan. The CTS 360 may evaluate clock signals of the circuit after or during placement of the components and traces. The CTS 360 may perform signal tracing and timing analysis to determine or adjust the trace routing and placement of components.

The GDS system 357 may be configured to perform graphical design operations for the output from the physical design system 356, such as physical design files, including the gate level placement locations and dimensions and circuit routing dimensions and paths. The GDS system 357 may convert the physical design file for the circuit to a graphical design file for use by a circuit fabricator or fabrication system.

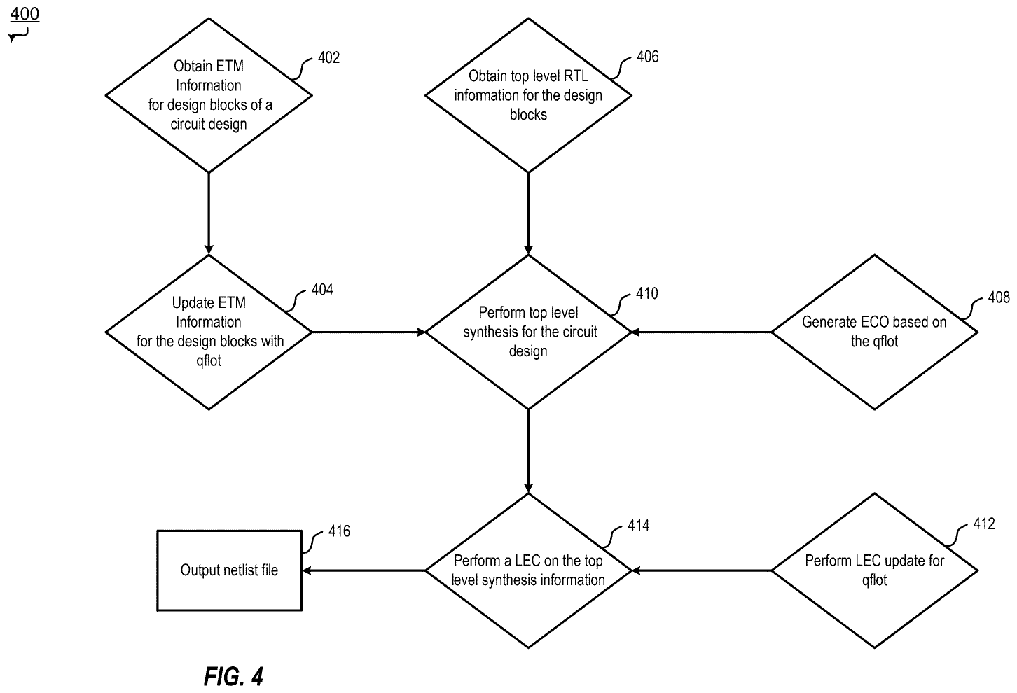

During operation, the system 301 may perform enhanced circuit design operations, including floating port identification operations and floating port based design modifications. The system 301 may incorporate the identified floating port information into the design process and use the information to identify unused logic associated with the identified floating ports and make changes (e.g., ECOs) based on the unused logic. The design changes may be generated automatically by one or more components or sub-systems of the system 301 and may be implemented in the synthesis of top level generation or generation of the netlist that is sent for physical design and the gate level placement and routing. Detailed operations of the system 301 are described further with reference to FIGS. 4-9.

Accordingly, the system 301 may be able to perform enhanced circuit design operations by utilizing the floating port identification information and techniques described herein. Accordingly, the circuit design performance and resulting performance of circuits fabricated by the designs produced by the system 301 will be increased due to reductions in circuit area and power consumption, such as through reduced power leakage.

FIG. 4 is a flow diagram 400 illustrating enhanced circuit design operations and identifying floating port information according to some embodiments of the disclosure. In some implementations, the blocks or operations of the flow diagram 400 may be performed by any of the system 301 of FIG. 3, and components thereof. For example, the components of the system 301 of FIG. 3 may perform enhanced circuit design operations, including identifying floating port information and modifying a circuit design based on the identified floating port information, and unused logic associated therewith.

At block 402, the system obtains ETM Information for design blocks of a circuit design. For example, the system receives or generates ETM information for design blocks of a particular circuit design and for a particular circuit design, similar to as described to block 202 of FIG. 2. To illustrate, the system may receive or generate an ETM file, such as a library file, for each design block of the circuit plan. The ETM files may correspond to blocks at different levels of the circuit design, such as DL1, DL2, DL3, etc.

In some implementations, the system may receive ETM information for one or more blocks of a particular design that was generated by another device. In other implementations, the system may generate the ETM information based on block information. To illustrate, the system may generate ETM information based on CAD design file information and/or circuit design information. The ETM information includes hierarchical timing information. In a particular implementation, the ETM information does not indicate components of the block, but rather a signal flow or routing of the block and related timing formation for the signal flow or routing.

At block 404, the system updates the ETM information for the design blocks of the circuit design with floating port information (qflot). For example, the system identifies floating port information (qflot) for one or more design blocks of the circuit design. The floating port information may be determined manually or by an automated system or systems. The system may identify the floating port information (qflot) based on the ETM information (e.g., ETM library file information), from the top level RTL information, or both. The system may identify the floating port information (qflot) by analyzing library file information for each block to determine which ports are unused in each type of block for the overall circuit design.

After the floating porting information is obtained, the system then updates the ETM information for the design blocks of the circuit design with the identified floating port information (qflot) to enable identification of the floating ports throughout the design process and to enable optimization of the design. Optimization of the design may include identification of unused logic and modifications to the design to reduce the impact of the unused logic. The modifications may include removal, disconnection, replacement with dummy/non-functional components, etc.

At block 406, the system obtains top level RTL information for the design blocks of the particular circuit design. For example, the system receives or generates top level RTL information for the design blocks for the particular circuit design, similar as described to block 204 of FIG. 2. In some implementations, the system may receive top level RTL information for one or more blocks of the particular design that was generated by another device. In other implementations, the system may generate the top level RTL information based on block information, such as from a cell or hard macro database. To illustrate, the system may generate the top level RTL information based on CAD design file information and/or circuit design information. The top level RTL information may include or correspond to top level RTL information as described with reference to FIG. 2 and/or RTL data 368 as described with reference to FIG. 3.

At block 408, the system generates an engineering change order (ECO) for the design block based on the identified floating port information. For example, the system generates an ECO for one or more design blocks of the plurality of blocks based on the modified ETM information (e.g., modified ETM file with identified floating port information (qflot)), the modified RTL information (e.g., modified RTL file with identified floating port information (qflot)), or both. In some implementations, the ECO may be provided to a synthesis program for top level synthesis based on the ECO, and accordingly the identified floating port information (qflot). In other implementations, the ECO may be implemented prior to top level synthesis, such as implemented in the ETM information, the top level RTL information, or in the netlist information.

The ECO may be for the specific circuit design and may be in relation to or in terms of one or other blocks. To illustrate, the ECO may be applicable for all blocks of a certain type (e.g., B1) in a particular circuit design or only when the blocks have a certain location (e.g., at DL1, DL2, or DL3) or certain type of relationship, such as coupled to or part of another type of block (e.g., included in block type B2). The ECO may be generated for and/or performed in the ETM information, top level RTL information, or both. This may be known as performing the ECO prior to compiling/synthesis. Alternatively, the ECO may be accounted for during or after synthesis and/or generation of the netlist file. In some implementations, multiple ECOs may be generated for the specific circuit design. For example, multiple ECOs may be generated for a specific block type and/or one or more ECOs may be generated for multiple different types of blocks.

In some implementations, the CAD flow or process may be updated or modified to perform the ECO in the netlist before compiling. For example, a CAD script may be added to the library filed (.lib) to generate and/or perform ECOs based on the identified floating port information.

At block 410, the system performs top level synthesis for the circuit design. For example, the system performs top level synthesis for the circuit design based on the ETM information and the top level RTL information to generate top level synthesis information, similar to as described to block 206 of FIG. 2. To illustrate, the system may combine or synthesize the information from the ETM files and the top level RTL files to generate netlist information, such as a netlist file. The generated netlist information, such as netlist file(s), may be for the circuit design as a whole and/or for the individual blocks.

In some implementations, an RTL description of the block is converted to a gate-level description of the block by a logic synthesis tool, such as Synopsis. The synthesis results may be used for placement and routing tools to create a physical layout of the block and circuit.

As compared to the top level synthesis performed at block 206 of FIG. 2, the top level synthesis performed at block 410 of FIG. 4 includes, incorporates, or is otherwise performed based on the identified floating port information, such as floating port data 462 and/or modified ETM data 372. This enables the process of flow diagram 400 to account for the identified floating port information and disconnect and/or remove unused logic associated with the floating ports of the identified floating port information.

At block 412, the system performs an LEC update for the identified floating port information (qflot). For example, the system generates LEC update information based on the identified floating port information (qflot). The LEC update information is provided to the device or tool that then performs the LEC on the synthesis information, and can then perform the LEC update for the identified floating port information (qflot).

In some implementations, the CAD flow or process may be updated or modified to perform the LEC update for the modified netlist information based on the identified floating port information (e.g., the netlist where unused logic associated with the identified floating port information is disconnected or removed). For example, a CAD script may be added to the library file(s) (.lib) or netlist file(s) to understand the modified blocks of the circuit design based on the identified floating port information.

At block 414, the system performs an LEC on the top level synthesis information. For example, the system performs an LEC on the top level synthesis information to verify the gate level placement from the timing information and/or RTL information. To illustrate, the system uses a logic simulation tool to verify the correctness of the top level synthesis information (e.g., netlist file(s)) based on the RTL description of the top level RTL information, and optionally the timing information of the ETM information. This may be done at the block level or circuit level. Logic simulation tools may use a design's RTL description to verify its correctness after synthesis.

As compared to the LEC performed at block 208 of FIG. 2, the LEC performed at block 414 of FIG. 4 includes, incorporates, or is otherwise performed based on the identified floating port information, such as floating port data 462 and/or modified ETM data 372. For example, the LEC performed at block 414 is performed based on the updated ETM and/or RTL design and/or modifications for the logic flow to account for ECOs made based on the identified floating port information. The LEC may be performed to account for such by utilizing modified logical equivalence checking information, or making adjustments during the LEC process to account for the logic flow changes caused by the ECOs. This enables the process of flow diagram 400 to account for the identified floating port information and to verify operation of the design after disconnection and/or removal of the unused logic associated with the floating ports of the identified floating port information.

At block 416, the system outputs a netlist file based on the performance of the LEC. For example, the system outputs a netlist file or files based on the performance of the LEC. To illustrate, the system generates a verified or final netlist file for the circuit and/or verified or final netlist files for the blocks thereof.

The netlist file or files may be provided to a physical design team and/or physical design software/tool for a physical design stage of the circuit plan. The physical design stage may include gate level or component (e.g., transistor) level placement and routing based on the gate level information in the netlist, that was generated based on ETM information and RTL information. The physical design stage may include clock signal tracing and connecting, such as clock tree synthesis (CTS) for the gates/components after placement. After the physical design stage is complete, the circuit may proceed to graphic design system (GDS) for creation of GDS file for use in fabrication. The GDS file may include all of the physical information of the circuit design.

Although the example of FIG. 4 describes an example of process that updated the ETM information, in other implementations, the ETM information may not be updated and/or other information may be updated. For example, the RTL information may be updated in addition to, or in the alternative of, the ETM information. As another example, the floating port information may be provided to the synthesis tool for top level synthesis, and the floating port information can be accounted for at the synthesis stage.

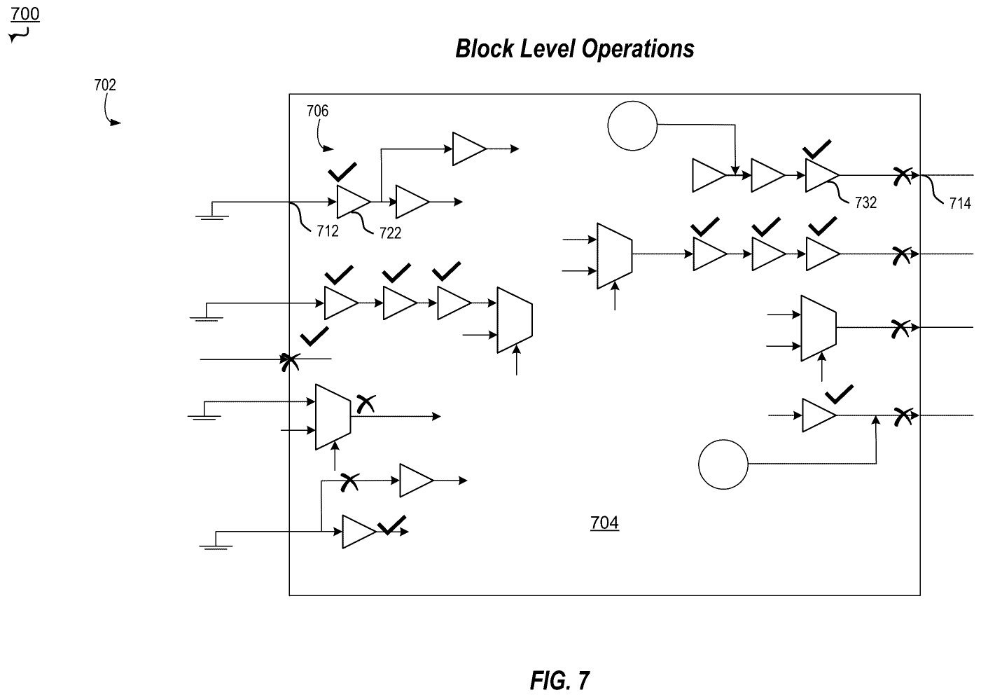

Referring to FIGS. 5-7, FIGS. 5-7 are each a block diagram illustrating a different level of a circuit plan or design. FIG. 5 illustrates a top level or full circuit plan of an SoC. FIGS. 6 and 7 each illustrate a different layer, such as a different layer of the SoC. For example, FIG. 6 illustrates a block level detail as compared to FIG. 5 and top level detail as compared to the block of FIG. 7.

Referring to FIG. 5, FIG. 5 is a block diagram 500 illustrating an example circuit plan for an SoC according to some embodiments of the disclosure. The SoC may be designed by th process described in FIGS. 2 and/or 4 and/or the system 301 of FIG. 3. The example circuit plan may include or correspond to a circuit design.

In the example of FIG. 5, a simplified top level diagram of the SoC 502 is shown having four hard macros (HMs). The four HMs include a first HM (HM1), a second HM (HM2), a third HM (HM3), a fourth HM (HM4). The HMs may include or correspond to larger components of the SoC, such as a central processor (e.g., CPU or core thereof), a modem, a DSP, a neural processor, a graphics processor, memory, storage, power control ICs, etc., as illustrative, non-limiting examples of HMs of a top level of an SoC. HMs may include many other components and/or building blocks or cells of components in other types of circuits and at other (e.g., non-top) levels of the circuits.

In FIG. 5, the four HMs may include or correspond to top level components of the SoC, and may not be contained within other blocks or cells, such as within other hard macros. The four HMs may include one or more lower or block levels, such one or more lower design layers, which may include one or more other HMs, or other cells or blocks. As examples of such lower or block level HMs, the HMs may include memory HMs, controller HMs, buffer HMs, etc., as illustrative, non-limiting examples of lower or block level HMs of the four top-level HMs of the SoC 502.

In FIG. 5, various design levels are shown in legend 550. Legend 550 illustrates three design levels (DLs), a first DL (DL1), a second DL (DL2), and a third DL (DL3). The design levels (or design layers) may be relative to one another. For example, the current level may be referred to as a top level or an above level may be referred to as a top level as compared to a lower level. In the example of FIG. 5, the third design level (DL3) represents a top level as compared to second design level (DL2), and in some implementations the third design level (DL3) may also represent the ultimate or actual top level design level of the circuit design/plan. The second design level (DL2) represents a top level as compared to a first design level (DL1). The second design level (DL2) also represents a block level as compared to the third design level (DL3). Although three design levels are illustrated in FIG. 5, in other implementations, there may be fewer design levels or more design levels. For example, the design may include more than three levels.

As illustrated in FIG. 5, each of the HMs may be at the third design level (DL3), include one or more blocks from the second design level (DL2), and/or the first design level (DL 1). Illustrative examples of design levels of the SoC 502 of FIG. 5 are described further with reference to FIGS. 6 and 7. The design levels of the SoC 502 may be further optimized or enhanced based on identified floating port information as described herein. For example, the design levels may be adjusted based on ECOs generated based on the identified floating port information, as described with reference to FIGS. 3 and 4.

Referring to FIGS. 6 and 7, design level components are shown for the particular design layer of the circuit plan or circuit design. For example, design level logic, buffers, and inverters are shown in FIGS. 6 and 7. FIGS. 6 and 7 each show an optimized block or design level with or after ECOs. In FIGS. 6 and 7, an “X” represents a disconnect or an ECO identified based on a floating port and/or based on unused logic associated with the floating port. A check mark represents logic, which is then adjusted or optimized by or after the disconnect or ECO. For example, when a disconnect is performed at a particular X, logic driving the particular port may be improved or optimized. The identified floating logic can be disconnected completely from power, such as by a gap in the trace, or the identified floating logic can be removed from the design altogether (e.g., not included in the netlist and not built). Connected logic or non-floating logic (e.g., not-identified logic which is not adjusted or optimized) is not shown in FIGS. 6 and 7 for simplicity. In actual designs, a majority of the logic may be not floating and connected between blocks and such logic not adjusted or disconnected by ECOs.

In FIG. 6, an example of top level operations and ECOs for the top level operations is illustrated. FIG. 6 depicts an example of using floating port information to identify unused logic and generate ECOs. In the example of FIG. 6, multiple ECOs may be generated as illustrated by the “X's” to disconnect the ports between the components of a top level (outside of a block 604), referred to as top level logic 602, and the components inside of the block 604, referred to as block level logic. The disconnected ports correspond to the ports identified as floating and/or marked as floating (qflot). In FIG. 6, the components inside the block 604 are not shown and may correspond to another design level of the circuit. An example of such lower level or layer design is illustrated in FIG. 7. As FIG. 6 is a representation of top level operations, the level or design level of FIG. 6 may include or correspond to a DL2, DL3, DL4, etc., of the SoC of FIG. 5.

As illustrated in FIG. 6., multiple ECOs are illustrated for input ports to block 604 from the top level logic 602 (e.g., logic from an upper level relative to block 604), and multiple ECOs are illustrated for output ports from block 604 to the top level logic 602. For example, with respect to a first input port 612 (e.g., top input port), the first input port 612 may not be used within the block 604 and the top level logic may be disconnected from the first input port 612. To illustrate, a trace between one or more components (e.g., an inverter 622) directly connected to the first input port 612 may be removed or a gap may be placed in the trace to disconnect the inverter from the first input port 612, and to prevent an output or signal from the inverter from being input to the block 604. This gap may reduce power consumption/power leakage by physically disconnecting the input port 612 from power, which may also disconnect corresponding logic of the block 604 and/or top level logic 602 from power. As another illustration, the first input port 612 can be removed altogether, such as an input pin and corresponding trace or traces may be removed from the design and not built.

As another example, with respect to a first output port 614 (e.g., top output port), the first output port 614 may not be used within the block 604, that is the block 604 may not output a signal from the first output port 614, or the first output port 614 may not be used to provide an output signal to certain components of the top level. In such cases, the top level logic (or portions thereof) may be disconnected from the first output port 614. To illustrate, a trace between one or more components (e.g., an inverter 632 and logic 634) directly connected to the first output port 614 may be removed or a gap may be placed in the trace to disconnect the one or more components from the first output port 614, and to prevent an output or signal from the first output port 614 of the block 604 from being provided to the one or more components. This gap may reduce power consumption/power leakage by physically disconnecting the one or more components from the output and/or from power. As another illustration, the first output port 614 can be removed altogether, such as an output pin and corresponding trace or traces may be removed from the design and not built if not connected to any top level logic 602.

Although FIG. 6 illustrates the first input and output ports 612 and 614 as being disconnected from one or more particular components and not being connected to any components, such is for simplicity only. The first input port 612, the first output port 614, or both, may be connected to one or more other components not shown in FIG. 6 for simplicity, and examples of some such components are further shown in the example of FIG. 7.

In FIG. 7, an example of block level operations and ECOs for the block level operations are illustrated. FIG. 7 depicts an example of using floating port information to identify unused logic and generate ECOs. In the example of FIG. 7, multiple ECOs may be generated as illustrated by the “X's” to disconnect the ports between the components of the block level operations (e.g., this design level or layer and inside of the block) and the upper or top level components outside of the block. The disconnected ports correspond to the ports identified as floating and/or marked as floating (qflot).

The components outside of the block are not shown in FIG. 7 and may correspond to another (e.g., upper) design level of the circuit. An example of such upper or higher level or layer design is illustrated in FIG. 6. As FIG. 7 is a representation of block level operations, the level or design level of FIG. 7 may include or correspond to a non-top level design layer, such as DL1, DL2, DL3, DL4, etc., of the SoC of FIG. 5.

As illustrated in FIG. 7. multiple ECOs are illustrated for input ports to block 704, and multiple ECOs are illustrated for output ports from block 714 from the top level (e.g., an upper level relative to block 704. For example, with respect to a first input port 712 (e.g., top input port), the first input port 712 may not be used within the block 704 and top level logic 702 may be disconnected from the first input port 712, such as described with reference to FIG. 6. Additionally, or alternatively, block level logic 706 may be disconnected from the first input port 712, and thus the top level logic 702. To illustrate, a trace between one or more components (e.g., an inverter 722) directly connected to the first input port 712 may be removed or a gap may be placed in the trace to disconnect the one or more components from the first input port 712, and to prevent an input or signal received by the first input port 712 from being provide to the one or more components of the block level logic 706 of the block 704. This gap may reduce power consumption/power leakage by physically disconnecting the input port 712 from power, which may also disconnect the corresponding block level logic 706 of the block 704 and/or top level logic 702 from power. As another illustration, the first input port 712 can be removed altogether, such as an input pin and corresponding trace or traces may be removed from the design and not built.

As another example, with respect to a first output port 714 (e.g., top output port), the first output port 714 may not be used within the block 704, that is the block 704 may no output a signal from the first output port 714, or the first output port 714 may not be used to provide an output signal to certain components of the top level. In such cases where the first output port 714 may not be used to provide an output signal to certain components of the top level, the top level logic 702 (or portions thereof) may be disconnected from the first output port 714, as described with reference to FIG. 6. In such cases where the first output port 714 may not be used within the block 704, the block level logic 706 (or portions thereof) may be disconnected from the first output port 714. To illustrate, a trace between one or more components (e.g., an inverter 732) directly connected to the first output port 714 may be removed or a gap may be placed in the trace to disconnect the one or more components from the first output port 714, and to prevent an output or signal from the one or more components of the block level logic 706 from being provided to the first output port 714. This gap may reduce power consumption/power leakage by physically disconnecting the one or more components the block level logic 706 from the output and/or from power and/or by physically disconnecting top level logic 702 (or portions thereof) from the output and/or from power. As another illustration, the first output port 714 can be removed altogether, such as an output pin and corresponding trace or traces may be removed from the design and not built if not connected to any top level logic 702.

Although FIG. 7 illustrates the first input and output ports 712 and 714 as being disconnected from one or more particular components and not being connected to any components, such is for simplicity only. The first input port 712, the first output port 714, or both, may be connected to one or more other components not shown in FIG. 6 for simplicity, and examples of some such components are described and shown in the example of FIG. 6.

Although ECOs, such as changes or disconnects, are shown with reference to ports between logic or blocks of two different layers in the examples of FIGS. 6 and 7, in other examples, ECOs may also occur intra-level and/or intra-block (e.g., between different logic of the same level or block) and may also occur between blocks (e.g., inter-block) of the same level.

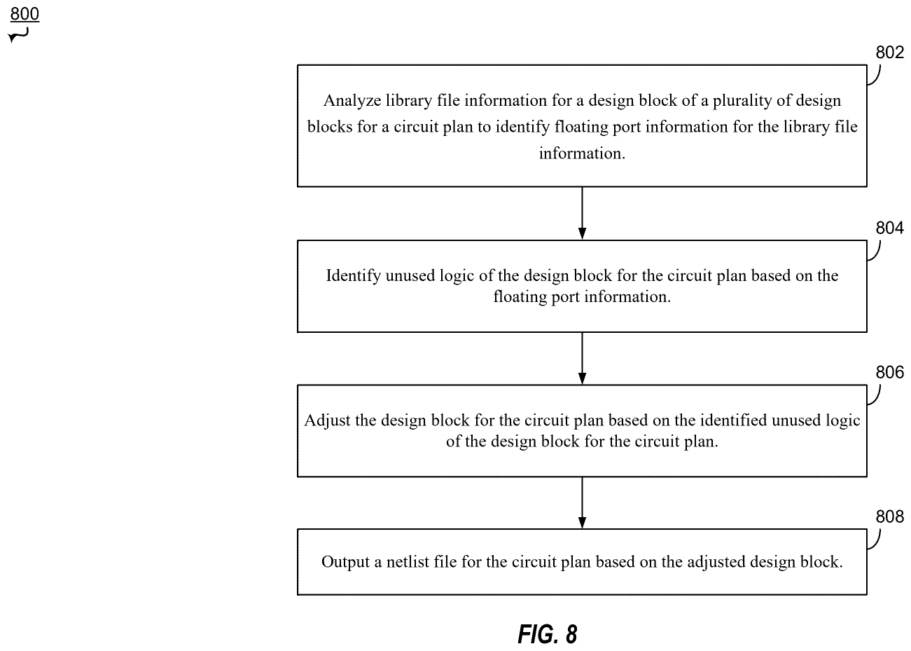

Referring to FIG. 8, FIG. 8 is a flow chart illustrating a method 800 for enhanced circuit design operations and identifying floating port information according to some embodiments of the disclosure. In some implementations, the blocks or operations of the method 800 may be performed by the components of the system 301 of FIG. 3. For example, the components of the system 301 of FIG. 3 may perform the enhanced circuit design operations of FIG. 8, including identifying floating port information and modifying a circuit design based on the identified floating port information, and unused logic associated therewith.

The method 800 includes, at block 802, analyzing library file information for a design block of a plurality of design blocks for a circuit plan to identify floating port information for the library file information. For example, the system analyzes library file information for a design block of a plurality of design blocks for a circuit plan to identify floating port information for the library file information, as described with reference to FIGS. 2-7. To illustrate, the system 301 may analyze ETM information in an ETM library file, to identify floating ports between design levels, as described with reference to FIGS. 4-8. The floating ports may correspond to ports which are not connected to components on other levels or are not driven by components on other levels. As another illustration, the system 301 may analyze RTL and/or netlist information in addition to, or in the alternative of ETM information, to identify the floating port information.

At block 804, the method 800 includes identifying unused logic of the design block for the circuit plan based on the floating port information. For example, the system identifies unused logic of at least one design block of the plurality of design blocks for the circuit plan based on the floating port information, as described with reference to FIGS. 2-7. To illustrate, the system 301 may automate this process by altering the CAD flow or process to include a script which identifies logic connected to the floating ports and generates ECOs based on the identified floating ports and/or logic. As another illustration, the system may modify the ETM file based on the floating port information and receive manual inputs for ECOs based on the floating port indications in the ETM file.

At block 806, the method 800 includes adjusting the design block for the circuit plan based on the identified unused logic of the design block for the circuit plan. For example, the system adjusts the design block for the circuit plan based on the identified unused logic of the design block for the circuit plan, as described with reference to FIGS. 2-7. The adjustment may include disconnection, removal, repurpose, replacement, etc., of the identified unused logic. To illustrate, the system 301 may implement the ECO and perform top level synthesis on the modified ETM and/or RTL information, which does not include the unused logic, or which has disconnected the unused logic. As another illustration, the system 301 may receive ETM and/or RTL information which includes indications for floating ports and/or unused logic, and the top level synthesis may include adjusting one or more design blocks of the circuit plan based on the floating port and/or unused logic information (e.g., indications).

At block 808, the method 800 includes outputting a netlist file for the circuit plan based on the adjusted design block. For example, the system outputs the netlist file for the circuit plan based on the adjusted design block, as described with reference to FIGS. 2-7. The netlist file may be generated during top level synthesis and then verified or checked during a logical equivalence check or stage. The LEC may include taking into account the changes from the identified floating ports and/or unused logic.

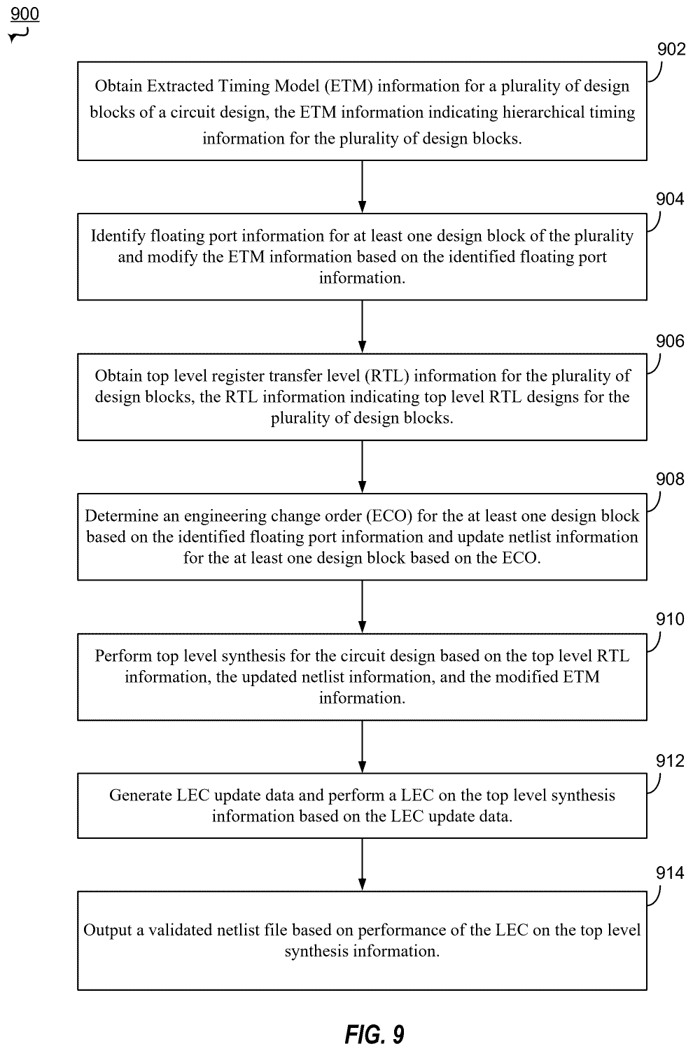

Referring to FIG. 9, FIG. 9 is a flow chart illustrating a method 900 for enhanced circuit design operations and identifying floating port information according to some embodiments of the disclosure. In some implementations, the method 900 may be performed by the components of the system 301 of FIG. 3. For example, the components of the system 301 of FIG. 3 may perform the enhanced circuit design operations of FIG. 9, including identifying floating port information and modifying a circuit design based on the identified floating port information, and unused logic associated therewith.

The method 900 includes, at block 902, obtaining ETM information for a plurality of design blocks of a circuit design, the ETM information indicating hierarchical timing information for the plurality of design blocks. For example, the system receives or generates an ETM library file information for each block of the plurality of design blocks of the circuit design, as described with reference to FIGS. 2-7. To illustrate, the system 301 may receive or retrieve ETM library file information from a hard macro or cell database. As another illustration, the system 301 may receive or retrieve netlist and/or RTL library file information for a plurality of design blocks from a hard macro or cell database and generate ETM files for the plurality of design blocks for a particular circuit design based on the netlist and/or RTL information and circuit design information.

At block 904, the method 900 includes identifying floating port information for at least one design block of the plurality and modifying the ETM information based on the identified floating port information. For example, the system identifies floating port information for at least one design block of the plurality based in part on the ETM library file and modifies the ETM library file based on the identified floating port information, as described with reference to FIGS. 2-7. To illustrate, the system may indicate the ports as qflot (e.g., qflot indication) in the ETM file or may generate a parameter or list of ports as a floating port (qflot list) in the ETM file. Additionally, or alternatively, the floating point formation may be determined based on a library file, the top level RTL information, and/or netlist information.

At block 906, the method 900 includes obtaining top level RTL information for the plurality of design blocks, the RTL information indicating top level RTL designs for the plurality of design blocks. For example, the system receives or generates the top level RTL files for each block of the plurality of design blocks for the circuit plan, as described with reference to FIGS. 2-7. To illustrate, the system 301 may receive or retrieve top level RTL library file information from a hard macro or cell database. As another illustration, the system 301 may receive or retrieve netlist and/or ETM library file information for a plurality of design blocks from a hard macro or cell database and generate top level RTL files for the plurality of design blocks for a particular circuit design based on the netlist and/or ETM information and circuit design information.

At block 908, the method 900 includes determining an engineering change order (ECO) for the at least one design block based on the identified floating port information and updating netlist information for the at least one design block based on the ECO. For example, the system determines an ECO for the at least one design block of the plurality based on the identified floating port information and updates netlist information for the at least one design block based on the ECO, as described with reference to FIGS. 2-7. To illustrate, CAD software or a CAD script may be used to generate ECOs based on the identified floating port information in or from the modified ETM file with or indicating the floating port information. In some implementations, the script may identify unused logic for a particular block and associated with the identified floating ports for the particular block based on the netlist or RTL information for the particular blocks. The ECO is configured to update the netlist information, and the netlist information may be updated prior to or with the top level synthesis. As another illustration, the ECOs may be generated by the synthesis tool directly based on the modified ETM file and/or the identified floating port information.

At block 910, the method 900 includes performing top level synthesis for the circuit design based on the top level RTL information and the modified ETM information. For example, the system performs top level synthesis for the circuit design (e.g., the design blocks thereof) based on the top level RTL information and the modified ETM information, as described with reference to FIGS. 2-7. To illustrate, the system performs top level synthesis on the information of the top level RTL file or files and the ETM files to generate a netlist file with gate level information based on the timing information of the ETM file and the register information of the top level RTL file. As at least the ETM file has been modified based on the identified floating port information, the top level synthesis process and netlist is also generated based on the identified floating port information and accounts for the identified floating port information. Additionally, the RTL file information and/or original netlist information may also be modified based on the identified floating port information and/or modified ETM file, and thus the top level synthesis process and netlist is generated based on the identified floating port information and accounts for the identified floating port information. As an example illustration, the netlist file may include a circuit design with disconnects for and/or removal of unused logic associated with the floating ports and corresponding to implemented ECOs that were generated based on the identified floating port information.

At block 912, the method 900 includes generating LEC update data and performing an LEC on the top level synthesis information based on the LEC update data. For example, the system performs an LEC on the top level synthesis information based on or using LEC update data, as described with reference to FIGS. 2-7. To illustrate, the system performs an LEC on the generated netlist information, which includes or is generated based on the ECOs determined from the floating port information. The LEC is performed by checking that the logic function of the netlist (e.g., gate level components and arrangement thereof) matches the logic function of the top level RTL file (or modified top level RTL file) and the timing information of the modified ETM file. The LEC is also performed based on or otherwise accounts for the adjusted logic of the circuit after the ECO as the top level synthesis information was generated based on the adjusted logic of the circuit. To account for the adjusted logic, the LEC may receive modifications to the logic function of the RTL and/or the timing of ETM file to account for the floating port information and/or ECOs, or the LEC may generate modification to the logic function of the RTL and/or the timing of ETM file to use in the verification of the synthesis and netlist file. In some implementations, the LEC process may include an optional step of adjusting the netlist file to modify the gate level design thereof to match information of the RTL and/or ETM files.

The LEC update data may be generated based on performing a LEC between the top level RTL information and the updated netlist information (e.g., updated netlist file). In some implementations, the LEC is between the top level register transfer level (RTL) versus the netlist file generated based on the identified floating port information and including modified logic associated with the ECO update, to determine LEC updated information based on the modified ETM for the design block identified.

At block 914, the method 900 includes outputting a validated netlist file based on performance of the LEC on the top level synthesis information. For example, the system validates the netlist file based on performance of the LEC update, and outputs the validated netlist file, as described with reference to FIGS. 2-7. The netlist file is generated based on the identified floating port information and includes modified logic associated with the identified floating port information. The validated netlist file (e.g., verified and modified netlist file) may be output to a physical design team or tool for gate level component placement and clock tracing operations.

In a first aspect, a method for circuit design includes: analyzing library file information for a design block of a plurality of design blocks for a circuit plan to identify floating port information for the library file information; identifying unused logic of the design block for the circuit plan based on the floating port information; adjusting the design block for the circuit plan based on the identified unused logic of the design block for the circuit plan; and outputting a netlist file for the circuit plan based on the adjusted design block.

In a second aspect, alone or in combination with the first aspect, the library file information corresponds to a library file for an extracted timing model of the design block and indicates timing analysis information for the design block.

In a third aspect, alone or in combination with the one or more of the above aspects, the method further includes: modifying the library file information for the design block based on the floating port information, and where to identify the unused logic of the design block for the circuit plan includes: identifying unused logic of the design block for the circuit plan based on the floating port information of the modified library file information.

In a fourth aspect, alone or in combination with the one or more of the above aspects, adjusting the design block for the circuit plan based on the identified unused logic includes: generating an engineering change order (ECO) for the identified unused logic for the design block; and modifying one or more components of the design block based on the ECO.

In a fifth aspect, alone or in combination with the one or more of the above aspects, the method further includes: performing an optimization process for the adjusted design block after modification of the one or more components to identify new operating parameters or timing parameters, additional changes, or a combination thereof, for the adjusted design block.

In a sixth aspect, alone or in combination with the one or more of the above aspects, modifying the one or more components of the design block includes: removing the unused logic from the design block; marking the unused logic as do not build or connect; disconnecting the unused logic from a particular port or other logic of the design block; creating a switch or break in paths associated with the unused logic; or removing a pin associated with the unused logic.

In a seventh aspect, alone or in combination with the one or more of the above aspects, the method further includes: performing top level synthesis for the circuit design based on top level register transfer level (RTL) information for the circuit plan and based on modified library file information for the design block, the modified library file including the floating port information, wherein the netlist file is generated based on performance of the top level synthesis.

In an eighth aspect, alone or in combination with the one or more of the above aspects, the netlist file includes gate level layout information, and wherein to output the netlist file for the circuit plan based on the adjusted design block includes: generating the netlist file based on the adjusted design block, wherein the netlist file includes ignore point commands for the identified floating ports indicated by the floating port information or does not include the identified floating ports; and providing the netlist file to physical design for physical placement of gate level components and clock tree synthesis (CTS).

In a ninth aspect, alone or in combination with the one or more of the above aspects, the method further includes: generating top level synthesis information for the circuit design based on the adjusted design block; performing a logical equivalence check (LEC) on the top level synthesis information; and generating the netlist based on performance of the LEC on the top level synthesis information.

In a tenth aspect, alone or in combination with the one or more of the above aspects, the method further includes: verifying the circuit design with the adjusted design block prior to output of the netlist file.

In an eleventh aspect, alone or in combination with the one or more of the above aspects, verifying the circuit design includes: performing formal verification (FV) of the circuit design based on the identified floating port information to generate ignore point command(s) for the identified floating ports.

In a twelfth aspect, alone or in combination with the one or more of the above aspects, the method further includes: updating CAD file information for the design block based on the identified floating port information, wherein the netlist file is generated based on the updated CAD file information.

In a thirteenth aspect, alone or in combination with the one or more of the above aspects, the method further includes: performing a logical equivalence check (LEC) between top level RTL information and the netlist file using modified timing information for the design block to generate LEC update information, wherein the netlist file is generated post optimization based on the updated CAD file information, and wherein the modified timing information is generated based on the updated CAD file information.

In a fourteenth aspect, alone or in combination with the one or more of the above aspects, each block of the plurality of design blocks has fixed ports.

In a fifteenth aspect, alone or in combination with the one or more of the above aspects, the library file for each block of the plurality of design blocks does not identify floating ports for a particular circuit design.

In a sixteenth aspect, alone or in combination with the one or more of the above aspects, the design block of the plurality of design blocks may include or correspond to a first level design block, a second level design block or a third level design block. For example, the first level design block referred as TOP, the second level design block is DL1, and the third level design blocks are DL2_block_1 and DL2_block_2 in a full chip circuit design. As another example, the first level design block is Top2, the second level design block is a BLOCK1, the third level design block is a SUB_BLOCK1. As yet another example, the first level design block is RXFE chip, the second level design block is a RX receive chain, RX feedback chain, etc., and the third level design block is an LNA, a Mixer, an oscillator, a divider, etc.

In a seventeenth aspect, alone or in combination with the one or more of the above aspects, the method further includes the design block of the plurality of design blocks may include or correspond to a modem, a graphics processor, a digital signal processor, a processing core, a central processing unit, or a neural logic processor.

In an eighteenth aspect, alone or in combination with the one or more of the above aspects, the design block of the plurality of design blocks may include one or more logic elements, wherein the logic elements include flops, buffers, inverters, transistors, or combo cells.

In a nineteenth aspect, alone or in combination with the one or more of the above aspects, the circuit plan is for a semiconductor device or a system-on-a-chip.

In a twentieth aspect, a method for circuit design includes: obtaining Extracted Timing Model (ETM) information for a plurality of design blocks of a circuit design, the ETM information indicating hierarchical timing information for the plurality of design blocks; identifying floating port information for at least one design block of the plurality of design block; modifying the ETM information based on the identified floating port information; obtaining top level register transfer level (RTL) information for the plurality of design blocks, the RTL information indicating top level RTL designs for the plurality of design blocks; determining an engineering change order (ECO) for the at least one design block based on the identified floating port information for the at least one design block; updating netlist information for the at least one design block based on the ECO; performing top level synthesis for the circuit design based on the top level RTL information and the modified ETM information to generate top level synthesis information; performing a logical equivalence check (LEC) between the top level RTL information and the updated netlist information to determine LEC update data; performing a LEC on the top level synthesis information based on the LEC update data; validating the updated netlist information based on performance of the LEC on the top level synthesis information; and outputting a validated netlist file based on validation of the updated netlist information, the validated netlist file generated based on the identified floating port information and including modified logic associated with the ECO.

In a twenty-first aspect, alone or in combination with the one or more of the above aspects, a circuit produced based on the validated netlist file output by the first aspect or the twentieth aspect.

In a twenty-second aspect, alone or in combination with the one or more of the above aspects, a hard macro of an integrated circuit includes: a first plurality of input ports coupled to one or more neighboring hard macros of the integrated circuit; a first plurality of output ports coupled to the one or more neighboring hard macros, the first plurality of input port and the first plurality of output ports coupled to a supply voltage of the integrated circuit; and one or more floating input ports or floating output ports that are not connected to any other hard macros of the integrated circuit, the one or more floating input ports or floating output ports are not coupled to any supply voltage of the integrated circuit.

In a twenty-third aspect, alone or in combination with the one or more of the above aspects, the hard macro further includes one or more logic circuits coupled to the first plurality of input ports, the first plurality of output ports, or both, wherein the one or more floating input ports or floating output ports are not coupled to any of the one or more logic circuits of the hard macro.

In a twenty-fourth aspect, alone or in combination with the one or more of the above aspects, the hard macro further includes one or more logic circuits coupled to the one or more floating input ports or floating output ports, the one or more logic circuits are not connected to any supply voltage of the integrated circuit.

In a twenty-fifth aspect, alone or in combination with the one or more of the above aspects, the one or more floating input ports or floating output ports and one or more logic circuits coupled thereto do not contribute to power leakage of the integrated circuit.

In a twenty-sixth aspect, alone or in combination with the one or more of the above aspects, a floating port corresponds to a port or pin of a hard macro or circuit block or cell of an integrated circuit that is not connected to a port or pin of another hard macro or circuit block or cell of the same design level or of a higher design level of the integrated circuit, a port or pin of a hard macro or circuit block or cell of the integrated circuit that is not driven or connected to a load (e.g., not connected to a supply voltage), or both.

In a twenty-seventh aspect, alone or in combination with the one or more of the above aspects, floating logic corresponds to a logic of a hard macro or circuit block or cell of an integrated circuit that is coupled to a floating port or pin, not coupled to a supply voltage, or both.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for circuit design, comprising:
analyzing library file information for a design block of a plurality of design blocks for a circuit plan to identify floating port information for the library file information;
identifying unused logic of the design block for the circuit plan based on the floating port information;
adjusting the design block for the circuit plan based on the identified unused logic of the design block for the circuit plan; and
outputting a netlist file for the circuit plan based on the adjusted design block.

2. The method of claim 1, wherein the library file information corresponds to a library file for an extracted timing model of the design block and indicates timing analysis information for the design block.

3. The method of claim 1, further comprising:
modifying the library file information for the design block based on the floating port information, and wherein identifying the unused logic of the design block for the circuit plan includes:
identifying unused logic of the design block for the circuit plan based on the floating port information of the modified library file information.

4. The method of claim 3, wherein adjusting the design block for the circuit plan based on the identified unused logic includes:
generating an engineering change order (ECO) for the identified unused logic for the design block; and
modifying one or more components of the design block based on the ECO.

5. The method of claim 4, further comprising:
performing an optimization process for the adjusted design block after modification of the one or more components to identify new operating parameters or timing parameters, additional changes, or a combination thereof, for the adjusted design block.

6. The method of claim 4, wherein modifying the one or more components of the design block includes:
removing the unused logic from the design block;
marking the unused logic as do not build or connect;
disconnecting the unused logic from a particular port or other logic of the design block;
creating a switch or break in paths associated with the unused logic; or
removing a pin associated with the unused logic.

7. The method of claim 1, further comprising:
performing top level synthesis for the circuit design based on top level register transfer level (RTL) information for the circuit plan and based on modified library file information for the design block, the modified library file including the floating port information, wherein the netlist file is generated based on performance of the top level synthesis.

8. The method of claim 1, wherein the netlist file includes gate level layout information, and wherein to output the netlist file for the circuit plan based on the adjusted design block includes:
generating the netlist file based on the adjusted design block, wherein the netlist file includes ignore point commands for the identified floating ports indicated by the floating port information or does not include the identified floating ports; and
providing the netlist file to physical design for physical placement of gate level components and clock tree synthesis (CTS).

9. The method of claim 1, further comprising:
generating top level synthesis information for the circuit design based on the adjusted design block;
performing a logical equivalence check (LEC) on the top level synthesis information; and
generating the netlist based on performance of the LEC on the top level synthesis information.

10. The method of claim 1, further comprising:
verifying the circuit design with the adjusted design block prior to output of the netlist file.

11. The method of claim 10, wherein verifying the circuit design includes:
performing formal verification (FV) of the circuit design based on the identified floating port information to generate an ignore point command for the identified floating ports.

12. The method of claim 1, further comprising:
updating CAD file information for the design block based on the identified floating port information, wherein the netlist file is generated based on the updated CAD file information.

13. The method of claim 12, further comprising:
performing a logical equivalence check (LEC) between top level RTL information and the netlist file using modified timing information for the design block to generate LEC update information, wherein the netlist file is generated post optimization based on the updated CAD file information, and wherein the modified timing information is generated based on the updated CAD file information.

14. The method of claim 1, wherein each block of the plurality of design blocks has fixed ports, wherein the library file information for each block of the plurality of design blocks does not identify floating ports for a particular circuit design, and wherein the design block of the plurality of design blocks may include or correspond to a first level design block, a second level design block or a third level design block.

15. A circuit produced based on the validated netlist file output by the method of claim 1.

16. A method for circuit design, comprising:
obtaining Extracted Timing Model (ETM) information for a plurality of design blocks of a circuit design, the ETM information indicating hierarchical timing information for the plurality of design blocks;
identifying floating port information for at least one design block of the plurality of design block;
modifying the ETM information based on the identified floating port information;
obtaining top level register transfer level (RTL) information for the plurality of design blocks, the RTL information indicating top level RTL designs for the plurality of design blocks;
determining an engineering change order (ECO) for the at least one design block based on the identified floating port information for the at least one design block;
updating netlist information for the at least one design block based on the ECO;
performing top level synthesis for the circuit design based on the top level RTL information and the modified ETM information to generate top level synthesis information;
performing a logical equivalence check (LEC) between the top level RTL information and the updated netlist information to determine LEC update data;
performing a LEC on the top level synthesis information based on the LEC update data;
validating the updated netlist information based on performance of the LEC on the top level synthesis information; and
outputting a validated netlist file based on validation of the updated netlist information, the validated netlist file generated based on the identified floating port information and including modified logic associated with the ECO.

17. A circuit produced based on the validated netlist file output by the method of claim 16.

18. A hard macro of an integrated circuit comprising:
a first plurality of input ports coupled to one or more neighboring hard macros of the integrated circuit;
a first plurality of output ports coupled to the one or more neighboring hard macros, the first plurality of input port and the first plurality of output ports coupled to a supply voltage of the integrated circuit; and
one or more floating input ports or floating output ports that are not connected to any other hard macros of the integrated circuit, the one or more floating input ports or floating output ports are not coupled to any supply voltage of the integrated circuit.

19. The hard macro of claim 18, further comprising one or more logic circuits coupled to the first plurality of input ports, the first plurality of output ports, or both, wherein the one or more floating input ports or floating output ports are not coupled to any of the one or more logic circuits of the hard macro.

20. The hard macro of claim 18, further comprising one or more logic circuits coupled to the one or more floating input ports or floating output ports, the one or more logic circuits are not connected to any supply voltage of the integrated circuit.
